(19) United States
(12) Patent Application Publication
(10) Pub. No.: US 2023/0267482 A1
(43) Pub. Date: Aug. 24, 2023

(54) Vehicle Dispatch System and Vehicle Dispatch Method

(71) Applicants: Hyundai Motor Company, Seoul (KR); Kia Corporation, Seoul (KR)

(72) Inventor: Nahyeon Pak, Anyang-si (KR)

(21) Appl. No.: 17/895,734

(22) Filed: Aug. 25, 2022

(30) Foreign Application Priority Data
Dec. 13, 2021 (KR) 10-2021-0178081

(51) Int. Cl. G06Q 30/0202; G06Q 50/30; G06Q 30/0645

(52) U.S. Cl. CPC G06Q 30/0202; G06Q 50/30; G06Q 30/0645

(57) ABSTRACT

A method for dispatching a vehicle includes receiving vehicle requests including vehicle dispatch conditions, determining a same place common group including one vehicle request having a first departure point and a first arrival point and one other vehicle request having the same departure point as the first departure point or the first arrival point and having the same arrival point as the other of the first departure point and the first arrival point, determining a same vehicle sharing group including one vehicle request among first vehicle requests which belongs to the same place common group and an other one vehicle request among the first vehicle requests having a use time later than a use time of the one vehicle request and having the same departure point as an arrival point of the one vehicle request, generating a time table, and dispatching a vehicle.

### CROSS-REFERENCE TO RELATED APPLICATIONS

This application claims priority to and the benefit of Korean Patent Application No. 10-2021-0178081 filed in the Korean Intellectual Property Office on Dec. 13, 2021, the entire contents of which are incorporated herein by reference.

### TECHNICAL FIELD

The present disclosure relates to a vehicle dispatch system and a vehicle dispatch method.

### BACKGROUND

For users who intend to use a service which rents a vehicle, there may be a demand for using the vehicle for a short term and a demand for using the vehicle for a long term. When the users intend to use the vehicle for a long term, a rent period of the vehicle is long, but a period of time when the users actually use the vehicle may be shorter than the rent period. For example, the corresponding users may use the vehicle only during a commute time on weekdays, on weekends, or during the daytime on weekdays. In such an environment, user satisfaction for a long-term rent service may be low due to a short vehicle use compared with high rent cost.

Accordingly, in spite of the long term, a vehicle rent service is required which can satisfy needs of users who intend to use the vehicle only for a specific time during the day.

The above information disclosed in this background section is only for enhancement of understanding of the background of the invention, and therefore it may contain information that does not form the prior art that is already known to a person of ordinary skill in the art.

### SUMMARY

Embodiments of the present disclosure can provide a service which rents one vehicle to multiple users according to a use place of a vehicle.

An exemplary embodiment of the present disclosure provides a vehicle dispatch method including receiving, by a server, a plurality of vehicle requests including vehicle dispatch conditions, respectively from a plurality of user terminals, determining, by the server, one vehicle request having a first departure point and a first arrival point among the plurality of vehicle requests, and at least one other vehicle request having the same departure point as any one of the first departure point and the first arrival point, and having the same arrival point as the other one of the first departure point and the first arrival point among the plurality of vehicle requests as a same place common group, determining, by the server, one vehicle request among a plurality of first vehicle requests which belong to the same place common group, and the other one vehicle request among the plurality of first vehicle requests having a use time later than a use time of the one vehicle request and having the same departure point as an arrival point of the one vehicle request as a same vehicle sharing group, generating, by the server, a time table including information on a vehicle dispatched according to the use time and a user who requests the vehicle with respect to a plurality of second vehicle requests which belong to the same vehicle sharing group, and dispatching, by the server, one vehicle in the same vehicle sharing group, in which the vehicle dispatch condition includes a departure point, an arrival point, and a use time for a movement path.

The determining as the same place common group may further include matching, by the server, one place common group including a vehicle request having a second departure point and a second arrival point among a plurality of place common groups, and at least one other place common group including a vehicle request having a departure point contiguous to any one of the second departure point and the second arrival point, and having an arrival point contiguous to the other one of the second departure point and the second arrival point as a contiguous place common group.

The vehicle dispatch method may further include receiving, by the server, a modified vehicle request including a changed use time from a user terminal which makes any one vehicle request of the plurality of second vehicle requests, and determining, by the server, the modified vehicle request as an existing vehicle sharing group when there is no first comparison target request corresponding to the same condition request as the modified vehicle request among the plurality of second vehicle requests, and the modified vehicle request may be determined as the existing vehicle sharing group.

The vehicle dispatch method may further include transmitting, by the server, a transfer acceptance inquiry signal to a user terminal which makes the first comparison target request when there is the first comparison target request, and determining, by the server, the modified vehicle request as the existing vehicle sharing group when receiving a transfer acceptance signal from the user terminal which makes the first comparison target request.

The vehicle dispatch method may further include transmitting, by the server, a together riding acceptance inquiry signal to the user terminal which makes the first comparison target request and the user terminal which makes the modified request, setting, by the server, the user terminal which makes the first comparison target request and the user terminal which makes the modified request as one user group when each of the user terminal which makes the first comparison target request and the user terminal which makes the modified request accepts together riding, and determining, by the server, the one user group as the existing vehicle sharing group.

The vehicle dispatch method may further include judging, by the server, whether there is the other vehicle sharing group in the existing place common group of the modified vehicle request when there is no first comparison target request and the modified vehicle request may not be determined as the existing vehicle sharing group.

The vehicle dispatch method may further include determining, by the server, the modified vehicle request as the other vehicle sharing group when there is no second comparison target request corresponding to the same condition request as the modified vehicle request among a plurality of third vehicle requests which belong to the other vehicle sharing group when there is the other vehicle sharing group, and the modified vehicle request may be determined as the other vehicle sharing group.

The vehicle dispatch method may further include transmitting, by the server, the transfer acceptance inquiry signal to a user terminal which makes the second comparison target request when there is the second comparison target request, and determining, by the server, the modified vehicle request as the other vehicle sharing group when receiving the transfer acceptance signal from the user terminal which makes the second comparison target request.

The vehicle dispatch method may further include transmitting, by the server, a together riding acceptance inquiry signal to the user terminal which makes the second comparison target request and the user terminal which makes the modified request, setting, by the server, the user terminal which makes the second comparison target request and the user terminal which makes the modified request as one user group when each of the user terminal which makes the second comparison target request and the user terminal which makes the modified request accepts together riding, and determining, by the server, the one user group as the other vehicle sharing group.

The vehicle dispatch method may further include judging, by the server, whether there is a contiguous vehicle sharing group in a contiguous place common group corresponding to the existing place common group of the modified vehicle request when there is no second comparison target request and the modified vehicle request may not be determined as the other vehicle sharing group.

The vehicle dispatch method may further include determining, by the server, the modified vehicle request as the contiguous vehicle sharing group when there is no third comparison target request corresponding to the same condition request as the modified vehicle request among a plurality of fourth vehicle requests which belong to the contiguous place common group when there is the contiguous vehicle sharing group, and the modified vehicle request may be determined as the contiguous vehicle sharing group.

The vehicle dispatch method may further include transmitting, by the server, a transfer acceptance inquiry signal to a user terminal which makes the third comparison target request when there is the third comparison target request, and determining, by the server, the modified vehicle request as the contiguous vehicle common group when receiving a transfer acceptance signal from the user terminal which makes the third comparison target request.

The vehicle dispatch method may further include transmitting, by the server, a together riding acceptance inquiry signal to the user terminal which makes the third comparison target request and the user terminal which makes the modified request, setting, by the server, the user terminal which makes the third comparison target request and the user terminal which makes the modified request as one user group when each of the user terminal which makes the third comparison target request and the user terminal which makes the modified request accepts together riding, and determining, by the server, the one user group as the contiguous vehicle sharing group.

The vehicle dispatch method may further include transmitting, by the server, a signal for inquiring whether one vehicle is singly dispatched in the user terminal which makes the modified vehicle request when there is no third comparison target request and the modified vehicle request may not be determined as the contiguous vehicle sharing group.

Another exemplary embodiment of the present disclosure provides a server including an analysis unit analyzing, when receiving a plurality of vehicle requests including vehicle dispatch conditions respectively from a plurality of user terminals, the plurality of vehicle requests to generate information on a departure point, an arrival point, and a use time, with respect to each of the plurality of vehicle requests, and a classification unit determining one vehicle request having a first departure point and a first arrival point among the plurality of vehicle requests, and at least one other vehicle request having the same departure point as any one of the first departure point and the first arrival point, and having the same arrival point as the other one of the first departure point and the first arrival point among the plurality of vehicle requests as the same place common group, and determining one vehicle request among a plurality of first vehicle requests which belong to the same place common group, and the other one vehicle request among the plurality of first vehicle requests having a use time later than a use time of the one vehicle request and having the same departure point as an arrival point of the one vehicle request as the same vehicle sharing group, in which the vehicle dispatch condition includes a departure point, an arrival point, and a use time for a movement path.

The analysis unit may analyze, when receiving a use time change request from one of the plurality of user terminals, the received use time change request to generate information on the changed use time, and the classification unit may determine the place common group and the vehicle sharing group based on the information on the use time change request, and correct a time table of the vehicle sharing group.

The classification unit may judge whether to determine a modified vehicle request for making the use time change request an existing vehicle sharing group to which the vehicle request belongs, judge, when the modified vehicle request may not be determined as the existing vehicle sharing group, whether to determine the vehicle as the other vehicle sharing group in the existing place common group to which the vehicle request belongs, and judge, when the modified vehicle request may not be determined as the other vehicle sharing group, whether to determine the vehicle as a contiguous vehicle sharing group in a contiguous place common group corresponding to the existing place common group to which the vehicle request belongs.

Provided are a vehicle dispatch system and a vehicle dispatch method which can dispatch one vehicle for multiple users of which use times do not overlap according to a use place of a vehicle such as a departure point and an arrival point to enhance satisfaction of a user for a vehicle rent service in providing a vehicle rent service.

### BRIEF DESCRIPTION OF THE DRAWINGS

FIG. 1 is a block diagram schematically illustrating a configuration of a vehicle dispatch system according to an exemplary embodiment.

FIG. 2 is a flowchart of a vehicle dispatch method according to an exemplary embodiment.

FIG. 3 is a detailed flowchart for step S3 in FIG. 2.

FIG. 4 is an exemplary diagram for a vehicle sharing group-specific time table.

FIG. 5 is a flowchart according to an exemplary embodiment of a server which receives a use time change request.

FIGS. 6, 7, and 8 are detailed flowcharts of step S7 in FIG. 5.

The following reference identifiers may be used in connection with the accompanying drawings to describe exemplary embodiments of the present disclosure.
1: Vehicle dispatch system
10: Server
110: Control unit
120: Dispatch unit
130: Classification unit
140: Analysis unit
150: Database
20: Vehicle
30: User terminal
310: Application

### DETAILED DESCRIPTION OF ILLUSTRATIVE EMBODIMENTS

Hereinafter, exemplary embodiments disclosed in this specification will be described in detail with reference to the accompanying drawings and the same or similar components are denoted by the same or similar reference numerals, and duplicated description thereof will be omitted. Suffixes “module” and/or “unit” for components used in the following description are given or combined for ease in preparation of the present disclosure only and do not have their own distinguished meanings or roles. Further, in describing an embodiment disclosed in the present disclosure, a detailed description of related known technologies will be omitted if it is determined that the detailed description makes the gist of the embodiment of the present disclosure unclear. Further, it is to be understood that the accompanying drawings are just used for easily understanding the exemplary embodiments disclosed in this specification and a technical spirit disclosed in this specification is not limited by the accompanying drawings and all changes, equivalents, or substitutes included in the spirit and the technical scope of the present invention are included.

Terms including an ordinary number, such as first and second, are used for describing various elements, but the elements are not limited by the terms. The terms are used only to distinguish one element from another element.

In the present application, it should be understood that terms such as “include” or “have” indicate that a feature, a number, a step, an operation, a component, a part or the combination thereof described in the specification is present, but does not exclude a possibility of presence or addition of one or more other features, numbers, steps, operations, components, parts or combinations thereof, in advance.

In a component controlling other components under a specific control condition among components according to an exemplary embodiment, a program implemented by a set of commands materializing a control algorithm required for controlling other components may be installed. The control component may process input data and stored data according to the installed program and generate output data. The control component may include a non-volatile memory storing the program and a memory storing the data.

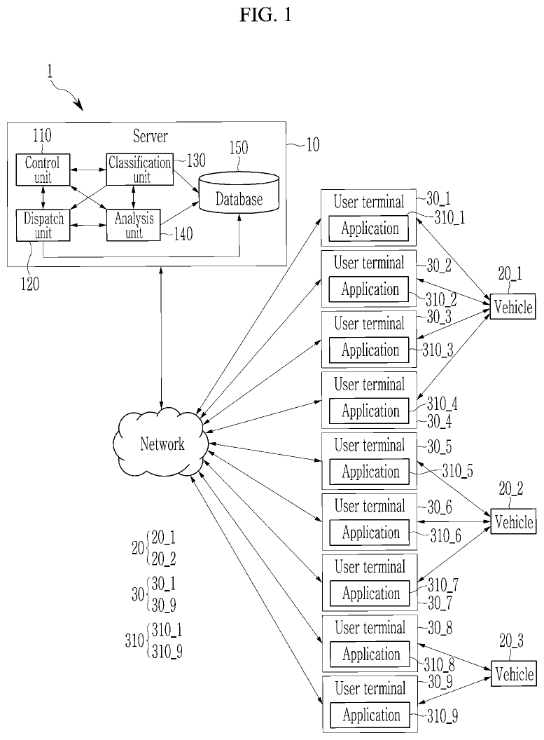

FIG. 1 is a block diagram schematically illustrating a configuration of a vehicle dispatch system according to an exemplary embodiment.

A vehicle dispatch system 1 may include a server 10, multiple vehicles 20_1 to 20_3, and multiple user terminals 30_1 to 30_9. The server 10 and the multiple user terminals 30_1 to 30_9 are connected to each other through a network. It is illustrated that the number of vehicles is 3 in FIG. 1, but the present disclosure is not limited thereto and the vehicle dispatch system 1 may include two or more vehicles. Hereinafter, when a common operation and a common technical feature of the multiple vehicles 20-1_ to 20_3 are described, the vehicles are represented as a vehicle 20. It is illustrated that the number of user terminals is 9 in FIG. 1, but the present disclosure is not limited thereto and the vehicle dispatch system 1 may include two or more user terminals. Multiple applications 310-1_ to 310_9 are installed in the multiple user terminals 30_1 to 30_9. Hereinafter, when a common operation and a common technical feature of the multiple user terminals 30_1 to 30_9 are described, the user terminals are represented as a user terminal 3o. Hereinafter, when a common operation and a common technical feature of the multiple applications 310_1 to 310_9 are described, the applications are represented as an application 310.

Hereinafter, it is described that a user of the user terminal 30_1 is A1, the user of a user terminal 30_2 is A2, the user of a user terminal 30_3 is A3, the user of a user terminal 30_4 is A4, the user of a user terminal 30_5 is A5, the user of a user terminal 30_6 is A6, the user of a user terminal 30_7 is A7, the user of a user terminal 30_8 is A8, and the user of a user terminal 30_9 is A9.

When the server 10 receives multiple vehicle requests from multiple user terminals 30, the server 10 may determine a place common group and a vehicle sharing group, generate a time table for each vehicle sharing group, and provide a service which dispatches a vehicle to a user which belongs to the vehicle sharing group based on the time table, for each of the multiple vehicle requests based on a vehicle dispatch condition included in each of the multiple vehicle requests. The time table may include a start time and an end time of a period requested by each of a plurality of users belonging to each car sharing group to use the vehicle. Hereinafter, the period requested by a user to use a vehicle is referred to as a use time. Further, when the server 10 receives a use time change request from one of the multiple user terminals 30, the server 10 may determine the place common group and the vehicle sharing group and provide a service which corrects the time table of the vehicle sharing group, for the use time change request based on a changed use time. The place common group is a group that binds two or more vehicle requests which are the same in two regions including a departure point and an arrival point. The vehicle sharing group is a group which binds two or more vehicle requests which may belong to the same place common group and may be dispatched with one vehicle 20. The server 10 may include a control unit no, a dispatch unit 120, a classification unit 130, an analysis unit 140, and a database iso.

When the user of the user terminal 30 is dispatched in the vehicle 20 through the server 10, the user may be granted with an authority (hereinafter, referred to as a use authority) which is capable of boarding the vehicle 20 and using the vehicle 20 through the user terminal 30 at a use time according to a dispatch time table. For example, the user terminal 30 may receive a digital key from the server 10, and the user may open a door of the vehicle 20 by using a digital key of the user terminal 30 and drive the vehicle 20 by starting the vehicle 20.

The control unit no may transmit, to each of the multiple user terminals 30, information on a vehicle sharing group including a corresponding user terminal. Hereinafter, the information on the vehicle sharing group may include a user-specific use time, vehicle information, and the like. The vehicle information may include a category of vehicle (e.g., a van, a car, a small car, etc.), a vehicle type, a vehicle model, etc.

When the analysis unit 140 receives a vehicle request or the use time change request from the multiple user terminals 30, the analysis unit 140 analyzes the received vehicle request to generate information on the departure point, the arrival point, and the use time, and analyzes the received use time change request to generate information on the changed use time. The use time may include a day (e.g., weekend or weekdays) in which the user intends to use the vehicle and a time (e.g., 09:00 to 12:00) at which the user intends to use the vehicle in the day in which the user intends to use the vehicle. Hereinafter, it will be assumed and described that a comparison between the use times is a comparison between times at which the user intends to use the vehicle in the same day.

The classification unit 130 may determine the place common group and the vehicle sharing group, and generate the time table of the vehicle sharing group, for each of the multiple vehicle requests based on the information generated by the analysis unit 140.

The dispatch unit 120 may dispatch the vehicle in the vehicle sharing group based on the vehicle sharing group-specific time table determined by the classification unit 130.

The user terminal 30 may be connected to the vehicle 20 through wireless communication. A wireless communication scheme may be implemented through near field communication (NFC) communication, Bluetooth™ communication, ultra-wide band communication, etc.

As such, the server 10 may grant the use authority for the vehicle 20 to the user terminal 30 and the user may use the vehicle 20 through the user terminal 30.

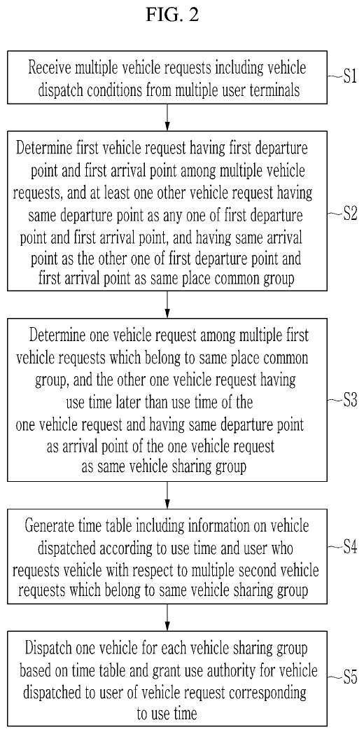

Hereinafter, referring to FIG. 2, a method for dispatching the vehicle by using the vehicle dispatch system 1 will be described in sequence.

FIG. 2 is a flowchart of a vehicle dispatch method according to an exemplary embodiment.

The analysis unit 140 may receive multiple vehicle requests including a vehicle dispatch condition from the multiple user terminals 30 (S1). The vehicle dispatch condition may include conditions regarding a departure point, an arrival point, a use time, a desired vehicle type, etc., for a path (hereinafter, referred to as a movement path) on which the user intends to move using the dispatched vehicle.

The user may input the vehicle dispatch condition into the user terminal 30 through the application 310, and the user terminal 30 may transmit the vehicle request including the input vehicle dispatch condition to the server 10 through the application 310. Further, the user may input the vehicle dispatch condition into the user terminal 30, and then input the changed use time through the application 310, and the user terminal 30 may transmit a use time change request including the input use time to the server 10 through the application 310.

The classification unit 130 may determine a first vehicle request having a first departure point and a first arrival point among the multiple vehicle requests, and at least one other vehicle request having the same departure point as any one of the first departure point and the arrival point, and the same arrival point as the other one of the first departure point and the first arrival point as the same place common group (S2).

The classification unit 130 may derive at least one second vehicle request having the same departure point and arrival point as the first departure point and the first arrival point among the multiple vehicle requests. The classification unit 130 may derive at least one third vehicle request having the first departure point as the arrival point and having the first arrival point as the departure point among the multiple vehicle requests. The classification unit 130 may determine at least one first, second, and third vehicle request as the same place common group.

With respect to the multiple vehicle requests which belong to the same place common group, the departure point of each vehicle request should be the same place as the departure point of the other vehicle request, and the arrival point should be the same place as the arrival point of the other vehicle request. Alternatively, with respect to the multiple vehicle requests which belong to the same place common group, the departure point of each vehicle request should be the same place as the arrival point of the other vehicle request, and the arrival point should be the same place as the departure point of the other vehicle request.

When the classification unit 130 judges the sameness between specific locations, if a distance between the specific locations is within a predetermined distance, the classification unit 130 may judge that the specific locations belong to the same location. The specific location means each of the departure point and the arrival point.

Further, the classification unit 130 may bind at least two contiguous place common groups among the multiple place common groups as a contiguous place common group. When it is determined whether the place common groups are contiguous, the classification unit 130 may consider departure points and arrival points of the multiple vehicle requests which belong to the place common groups, respectively. The classification unit may allow two regions including the departure points and the arrival points of the respective multiple vehicle requests included in the same place common group to be contiguous to two regions including the departure points and the arrival points of the respective multiple vehicle requests included in corresponding contiguous place common groups. For example, the classification unit 130 may derive, as the contiguous place common group, at least the other one place common group to which the vehicle request belongs to, which has the departure point (or arrival point) and the arrival point (or departure point) contiguous to one departure point and one arrival point among the multiple vehicle requests which belong to one of the multiple place common groups. The classification unit 130 may match each place common group and the contiguous place common group corresponding to each place common group with the multiple place common groups. For example, a place common group X2 to which a vehicle request having the departure point (or arrival point) and the arrival point (or departure point) contiguous to one departure point and one arrival point among the multiple vehicle requests which belong to a place common group X1 belongs may match the contiguous place common groups.

The classification unit 130 may determine, as the same vehicle sharing group jointly with one vehicle request, the other vehicle request having a use time later than a use time of one vehicle request among the multiple vehicle requests which belong to the same place common group, and having the same departure point as the arrival point of one vehicle request (S3).

Here, a case where the use time of the second vehicle request is later than the use time of the first vehicle request may mean a case where a departure estimated time of the second vehicle request among the multiple vehicle requests is later than an arrival estimated time of the first vehicle request.

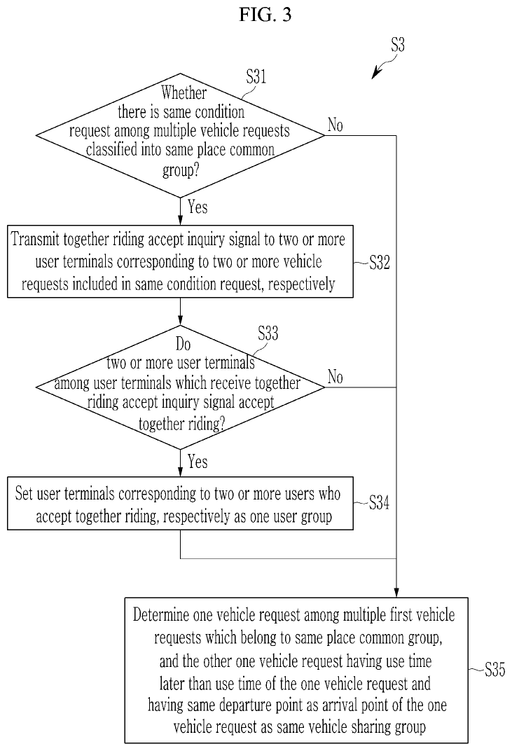

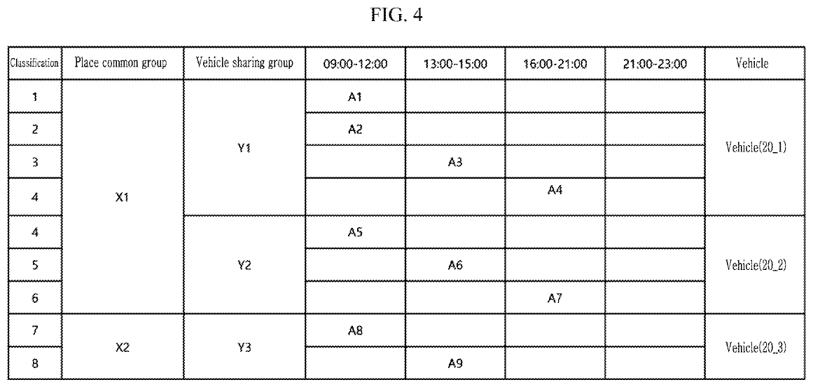

Hereinafter, a step of determining, by the server 10, the vehicle sharing group with respect to each of the multiple vehicle requests which belong to the same place common group will be described with reference to FIG. 3. Further, each step of FIG. 3 will be described by referring to an example for the vehicle sharing group-specific time table of FIG. 4.

FIG. 3 is a detailed flowchart for step S3 in FIG. 2.

FIG. 4 is an exemplary diagram for a vehicle sharing group-specific time table.

Referring to FIG. 4, a dispatch time table of the place common group X1 may include multiple vehicle sharing groups Y1 and Y2 included in the place common group X1, and user information corresponding to a use time-specific vehicle request of each of the multiple vehicle sharing groups Y1 and Y2.

In the example of FIG. 4, the place common group X1 may include the vehicle sharing group Y1 and the vehicle sharing group Y2. A user A1 which belongs to the vehicle sharing group Y1 may use a vehicle (e.g., 20_1) dispatched in the vehicle sharing group Y1 at 9:00 to 12:00. A user A2 which belongs to the vehicle sharing group Y1 may use the vehicle (e.g., 20_1) dispatched in the vehicle sharing group Y1 at 9:00 to 12:00. A user A3 which belongs to the vehicle sharing group Y1 may use a vehicle (e.g., 20_1) dispatched in the vehicle sharing group Y1 at 13:00 to 15:00. A user A4 which belongs to the vehicle sharing group Y1 may use a vehicle (e.g., 20_1) dispatched in the vehicle sharing group Y1 at 16:00 to 21:00. A user A5 which belongs to the vehicle sharing group Y2 may use a vehicle (e.g., 20_2) dispatched in the vehicle sharing group Y2 at 9:00 to 12:00. A user A6 which belongs to the vehicle sharing group Y2 may use the vehicle (e.g., 20_2) dispatched in the vehicle sharing group Y2 at 13:00 to 15:00. A user A7 which belongs to the vehicle sharing group Y2 may use the vehicle (e.g., 20_2) dispatched in the vehicle sharing group Y2 at 16:00 to 21:00. The place common group X2 may include a vehicle sharing group Y3. A user A8 which belongs to the vehicle sharing group Y3 may use a vehicle (e.g., 20_3) dispatched in the vehicle sharing group Y3 at 9:00 to 12:00. A user A9 which belongs to the vehicle sharing group Y3 may use the vehicle (e.g., 20_3) dispatched in the vehicle sharing group Y3 at 13:00 to 15:00.

The classification unit 130 may judge whether there are two or more vehicle requests (hereinafter, referred to as a same condition request) in which each of the departure point, the arrival point, and the use time is the same among the multiple vehicle requests classified into the same place common group (S31).

For example, when there is a vehicle request of the other user (e.g., A2) having the departure point, the arrival point, and the use time which are the same as the departure point, the arrival point, and the use time of the vehicle request of the user (e.g., A1), respectively, the classification unit 130 may match the vehicle request of the user A1 and the vehicle request of the other user A2 as the same condition request.

When there is the vehicle request corresponding to the same condition request, the classification unit 130 may transmit a together riding acceptance inquiry signal to two or more user terminals (e.g., 30_1 and 30_2) corresponding to two or more vehicle requests included in the same condition request, respectively (S32).

In embodiments of the present disclosure, together riding may represent that users corresponding to different user terminals, respectively board together in boarding the vehicle 20 such as a rental car, a taxi, etc.

When two or more user terminals (e.g., 30_1 and 30_2) among the user terminals 30_1 and 30_2 receiving the together riding acceptance inquiry signal accept the together riding (S33), the classification unit 130 may set the user terminals (e.g., 30_1 and 30_2) corresponding to two or more users (e.g., A1 and A2) accepting the together riding, respectively as one user group (S34).

When there is no vehicle request corresponding to the same condition request in step S31, when two or more user terminals do not accept the together riding in step S33, or subsequently to step S34, the classification unit 130 may determine, as the same vehicle sharing group jointly with one vehicle request, the other vehicle request having a use time later than a use time of one vehicle request among the multiple vehicle requests which belong to the same place common group, and having the same departure point as the arrival point of one vehicle request (S35).

When step S35 is performed subsequently to step S34, the classification unit 130 may determine the vehicle sharing group by treating that each vehicle request of one set user group is the vehicle request of one user. For example, when the user (e.g., A1) and the user (e.g., A2) are set as one user group, the classification unit 130 may determine the vehicle request of the user A1 and the vehicle request of the user A2 as the vehicle request having the same use time (e.g., 09:00 to 12:00) in the same vehicle sharing group (e.g., Y1).

The classification unit 130 may determine a vehicle request of another user (e.g., A4) having a use time later than the use time of the vehicle request of the other user (e.g., A3), and having the same departure point as the arrival point vehicle request of the other user (e.g., A3) as the same vehicle sharing group (e.g., Y1), and determine vehicle requests of two or more users as the same vehicle sharing group by the same scheme.

The classification unit 130 may generate a time table including information on vehicles (e.g., 20_1 to 20_3) dispatched according to the use time with respect to multiple vehicle requests which belong to the same vehicle sharing group and information on users (e.g., A1 to A9) of vehicle requests (S4). The time table illustrated in FIG. 4 includes time tables of multiple vehicle sharing groups Y1 to Y3 which belong to multiple place common groups X1 and X2. The vehicle information included in the time table may include a category of vehicle (e.g., a van, a car, a small car, etc.), a vehicle type, a vehicle model, etc. The user information included in the time table may include information regarding the vehicle dispatch conditions including the departure point, the arrival point, and the use time of the movement path, and data capable of identifying the user terminal.

The classification unit 130 may store the generated vehicle sharing group-specific time table in the database 150.

The dispatch unit 120 may dispatch one vehicle for each vehicle sharing group based on the time table, and grant the use authority for the vehicle dispatched to the user of the vehicle request corresponding to the use time (S5).

One vehicle (e.g., 20_1) dispatched in the same vehicle sharing group (e.g., Y1) may be determined based on a desired vehicle type of the multiple vehicle requests (e.g., A1 to A4) which belong to the vehicle sharing group.

The dispatch unit 120 may grant the use authority for the vehicle dispatched for a predetermined time range based on the use time of the vehicle request to the user corresponding to the vehicle request. For example, for a predetermined time range (08:45 to 12:15) based on the use time (09:00 to 12:00) of the vehicle request of the user A1, the dispatch unit 120 may grant the use authority for the vehicle 20_1 to the user A1. Then, the use authority for a time of 08:45 to 12:15 is granted to the user terminal 30_1 of the user A1.

The dispatch unit 120 may store the vehicle information for the vehicle 20_2 dispatched in the vehicle sharing group (e.g., Y2) in the database iso.

When the dispatch unit 120 grants the use authority for the dispatched vehicle (e.g., 20_2) to the corresponding users (e.g., M to A7), the control unit no may transmit information on the vehicle sharing group (e.g., Y2) including the corresponding user terminal to the respective user terminals (e.g., 30_5 to 30_7) of the respective corresponding users M to A7.

The user terminal 30 may make the use time change request to the server 10 after determining the vehicle sharing group for each of the multiple vehicle requests which belong to the same place common group or after generating the time table. The use time change request may be a request transmitted to the server 10 jointly with a use time to be changed through the user terminal when the user intends to change the use time of the vehicle request. The server 10 that receives the use time change request should determine a vehicle sharing group for a vehicle request (hereinafter, referred to as a ‘modification vehicle request’) corresponding to the use time change request. Hereinafter, the use time in the modification vehicle request may be the use time to be changed.

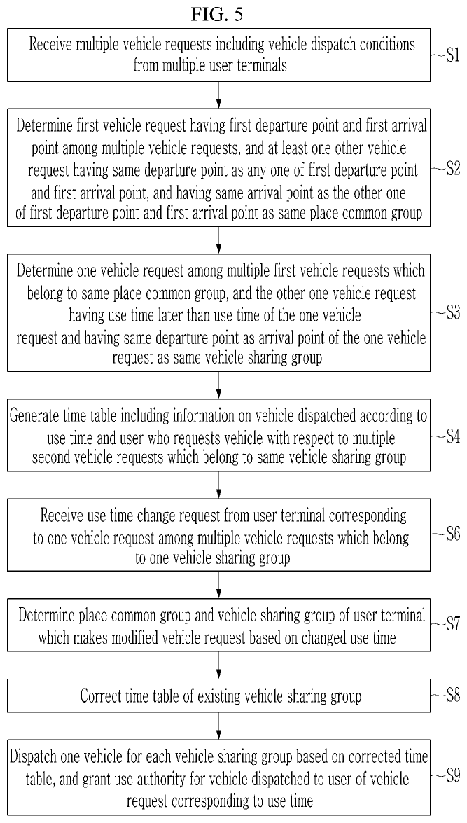

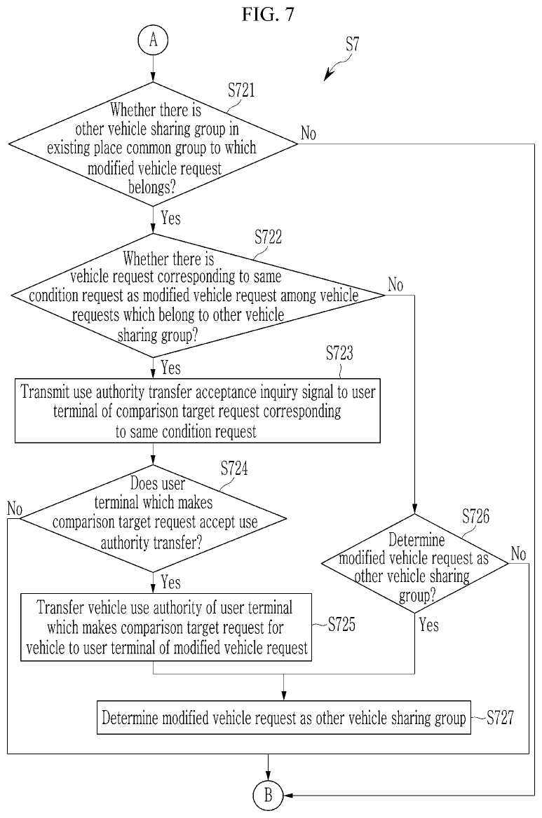

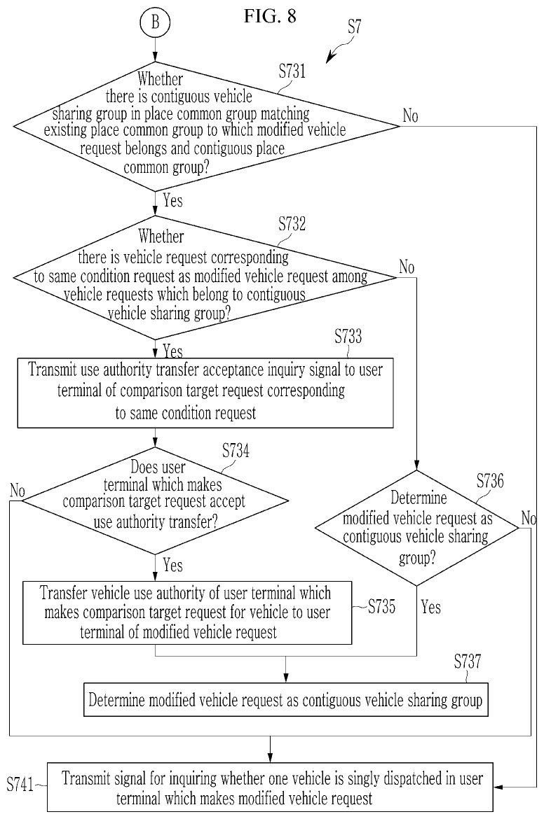

Hereinafter, referring to FIGS. 5 to 8, an operation of the server 10 receiving the use time change request from the user terminal 30 will be described.

FIG. 5 is a flowchart according to an exemplary embodiment of a server which receives a use time change request.

Steps S1 to S4 illustrated in FIG. 5 may be applied equally to steps S1 to S4 illustrated in FIG. 1.

The control unit no may receive the use time change request from the user terminal (e.g., 30_4) corresponding to one vehicle request among the multiple vehicle requests which belong to one vehicle sharing group (e.g., Y1) (S6).

The control unit no may deliver the received use time change request to the analysis unit 140.

The analysis unit 140 analyzes the received use time change request to generate information on the changed use time. The classification unit 130 may determine the place common group and the vehicle sharing group, and correct the time table of the vehicle sharing group, for the use time change request based on the information generated by the analysis unit 140.

The classification unit 130 may determine the place common group and the vehicle sharing group of the user terminal (e.g., 30_4) which makes the modified vehicle request based on the changed use time (S7).

The classification unit 130 judges whether the modified vehicle request may belong to an existing vehicle sharing group before the use time change request. When the modified vehicle request may not belong to the existing vehicle sharing group, the classification unit 130 judges whether the modified vehicle request may belong to the other vehicle sharing group in the existing place common group to which the modified vehicle request belongs. When the modified vehicle request may not belong to the other vehicle sharing group, the classification unit 130 judges whether the modified vehicle request may belong to the contiguous vehicle sharing group in the contiguous place common group corresponding in the existing place common group to which the modified vehicle request belongs.

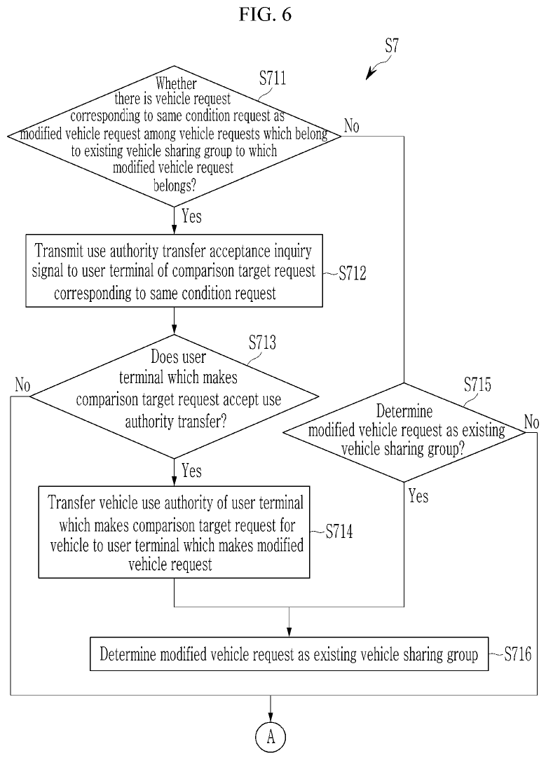

Hereinafter, step S7 of FIG. 5 will be described with reference to FIGS. 6 to 8.

FIGS. 6, 7, and 8 are detailed flowcharts of step S7 in FIG. 5.

Hereinafter, in the exemplary diagram of FIG. 4, a case where the user terminal 30_4 of the user A4 makes the use time change request will be assumed and described.

The classification unit 130 may judge whether there is a vehicle request corresponding to the same condition request as the modified vehicle request among the vehicle requests which belong to the existing vehicle sharing group Y1 to which the modified vehicle request belongs (S711). The existing vehicle sharing group to which the modified vehicle request belongs will be hereinafter referred to as the existing vehicle sharing group.

In step S711, when there is a comparison target request (e.g., the vehicle request of the user A3) corresponding to the same condition request as the modified vehicle request, the classification unit 130 may transmit a use authority transfer acceptance inquiry signal to the user terminal (e.g., 30_3) of the comparison target request corresponding to the same condition request (S712).

Alternatively, in step S711, when there is the comparison target request (e.g., the vehicle request of the user A3) corresponding to the same condition request as the modified vehicle request, the classification unit 130 may transmit the together riding acceptance inquiry signal to the user terminal (e.g., 30_3) which makes the comparison target request corresponding to the same condition request and the user terminal (e.g., 30_4) which makes the modified vehicle request, set the user terminal 30_3 of the comparison target request and the user terminal 30_4 of the modified vehicle request as one user group when each of the user terminal 30_3 of the comparison target request and the user terminal 30_4 of the modified vehicle request accepts the together riding, and determine one user group as the existing vehicle sharing group Y1, and the classification unit 130 may transmit the use authority transfer acceptance inquiry signal to the user terminal (e.g., 30_3) of the comparison target request corresponding to the same condition request when at least one of the user terminal 30_3 of the comparison target request and the user terminal 30_4 of the modified vehicle request does not accept the together riding (S712).

Here, the classification unit 130 allows one user group to share the use authority for the vehicle (e.g., 20_1) dispatched in the existing user terminal 30_3 which makes the comparison target request to determine one user group as the existing vehicle sharing group Y1.

The case where one user group shares the use authority for the vehicle (e.g., 20_1) dispatched in the existing user terminal 30_3 of the comparison target request may mean a case where multiple user terminals which belong to one user group are commonly dispatched with the vehicle 20_1 in a determined time zone to allow the user of each of the multiple user terminals to ride in the vehicle 20_1 together.

Hereinafter, it will be assumed and described that the changed use time of the user A4 who makes the modified vehicle request is the same as the use time (13:00 to 15:00) of at least one other user A3 of the other users A1, A2, and A3 included in the existing vehicle sharing group Y1. The classification unit 130 may determine whether the use authority is transferred by setting the vehicle request of the user A3 as the comparison target request.

The transfer acceptance inquiry signal means a signal for inquiring whether the user terminal 30_3 which makes the comparison target request accepts transferring the vehicle use authority for the vehicle 20_1 for the corresponding vehicle sharing group Y1 to the user terminal 30_4 which makes the modified vehicle request.

When the user terminal 30_3 which makes the comparison target request accepts the use authority transfer subsequently to step S712 (Yes at S713), the classification unit 130 may transfer the vehicle use authority for the vehicle 20_1 of the user terminal 30_3 which makes the comparison target request to the user terminal 30_4 which makes the modified vehicle request (S714).

In step S711, when there is no vehicle request corresponding to the same condition request as the modified vehicle request, the classification unit 130 may judge whether to determine the modified vehicle request as the existing vehicle sharing group Y1 (S715).

Hereinafter, it will be assumed and described that the changed use time of the user A4 who makes the modified vehicle request does not overlap with the use times of other users A1, A2, and A3 which belong to the existing vehicle sharing group Y1 (e.g., 21:00 to 23:00).

Hereinafter, the classification unit 130 may judge determining the vehicle request of the user who makes the use time change request as a specific vehicle sharing group according to a rule of the vehicle sharing group without changing the use time for the other user in a time table of the specific vehicle sharing group.

In the rule of the vehicle sharing group, the other vehicle request VR2 having the use time later than the use time of the vehicle request of one VR1 among multiple vehicle requests included in the vehicle sharing group, and having the same departure point as the arrival point of one vehicle request VR1 may be classified into the vehicle sharing group jointly with one vehicle request VR1. Alternatively, another vehicle request VR3 having the use time earlier than the use time of one vehicle request VR1 among the multiple vehicle requests included in the vehicle sharing group, and having the same arrival point as the departure point of one vehicle request VR1 may be determined as the vehicle sharing group jointly with one vehicle request VR1. Alternatively, one vehicle request VR1, the other vehicle request VR2, and another vehicle request VR3 may be all determined as one vehicle sharing group.

Subsequently to step S714 or in response to step S715, when the modified vehicle request may be included in the existing vehicle sharing group Y1, the classification unit 130 may determine the modified vehicle request as the existing vehicle sharing group Y1 (S716).

When the user terminal 30_3 which makes the comparison target request does not accept the use authority transfer in step S713 or when the modified vehicle request may not be determined as the existing vehicle sharing group Y1 in step S715, the classification unit 130 may judge whether the other vehicle sharing group Y2 belongs to the existing place common group X1 to which the modified vehicle request belongs (S721). The existing place common group to which the modified vehicle request belongs will be hereinafter referred to as the existing place common group.

The other vehicle sharing group Y2 means one other vehicle sharing group Y2 of other vehicle sharing groups other than the existing vehicle sharing group Y1 among one or more vehicle sharing groups Y1 and Y2 included in the existing place common group X1.

When the other vehicle sharing group Y2 belongs to the existing place common group X1 in step S721, the classification unit 130 may judge whether there is the vehicle request corresponding to the same condition request as the modified vehicle request among the vehicle requests which belong to the other vehicle sharing group Y2 (S722).

When there is a comparison target request (e.g., the vehicle request of the user A6) corresponding to the same condition request as the modified vehicle request in step S722, the classification unit 130 may transmit a use authority transfer acceptance inquiry signal to the user terminal (e.g., 30_6) of the comparison target request corresponding to the same condition request (S723).

Alternatively, in step S722, when there is the comparison target request (e.g., the vehicle request of the user A6) corresponding to the same condition request as the modified vehicle request, the classification unit 130 may transmit the together riding acceptance inquiry signal to the user terminal (e.g., 30_6) which makes the comparison target request corresponding to the same condition request and the user terminal (e.g., 30_4) which makes the modified vehicle request, set the user terminal 30_6 of the comparison target request and the user terminal 30_4 of the modified vehicle request as one user group when each of the user terminal 30_6 of the comparison target request and the user terminal 30_4 of the modified vehicle request accepts the together riding, and determine one user group as the other vehicle sharing group Y2, and the classification unit 130 may transmit the use authority transfer acceptance inquiry signal to the user terminal (e.g., 30_6) of the comparison target request corresponding to the same condition request when at least one of the user terminal 30_3 of the comparison target request and the user terminal 30_4 of the modified vehicle request does not accept the together riding (S723).

Here, the classification unit 130 allows one user group to share the use authority for the vehicle (e.g., 20_2) dispatched in the existing user terminal 30_6 which makes the comparison target request to determine one user group as the other vehicle sharing group Y2.

The case where one user group shares the use authority for the vehicle (e.g., 20_2) dispatched in the existing user terminal 30_6 of the comparison target request may mean a case where multiple user terminals which belong to one user group are commonly dispatched with the vehicle 20_2 in a determined time zone to allow the user of each of the multiple user terminals to ride in the vehicle 20_2 together.

The use authority is a use authority for the vehicle 20_2 dispatched in the user terminal which makes the comparison target request A6.

Hereinafter, it will be assumed and described that the changed use time of the user A4 who makes the modified vehicle request is the same as the use time of at least one user A6 of other users (e.g., A5, A6, and A7) included in the other vehicle sharing group Y2 of the existing place common group X1. The classification unit 130 may determine whether the use authority is transferred by setting the vehicle request of the user A6 as the comparison target request.

When the user terminal 30_6 which makes the comparison target request accepts the use authority transfer subsequently to step S723 (S724), the classification unit 130 may transfer the vehicle use authority for the vehicle 20_2 of the user terminal 30_6 which makes the comparison target request to the user terminal which makes the modified vehicle request (S725).

In step S722, when there is no vehicle request corresponding to the same condition request as the modified vehicle request, the classification unit 130 may judge whether to determine the modified vehicle request as the other vehicle sharing group Y2 (S726).

Hereinafter, it will be assumed and described that the changed use time of the user A4 who makes the modified vehicle request does not overlap with the use times of other users (As, A6, and A7) which belong to the other vehicle sharing group Y2 (e.g., 21:00 to 23:00).

Subsequently to step S725 or in response to step S726, when the modified vehicle request may be included in the other vehicle sharing group Y2, the classification unit 130 may determine the modified vehicle request as the other vehicle sharing group Y2 (S727).

When there is no other vehicle sharing group in the existing place common group X1 to which the user terminal of the modified vehicle request belongs in step S721, when the user terminal 30_6 which makes the comparison target request does not accept the use authority transfer in step S724, or when the modified vehicle request may not be determined as the other vehicle sharing group Y2 in step S726, the classification unit 130 may judge whether there is a contiguous vehicle sharing group Y3 in the existing place common group (e.g., X1) to which the modified vehicle request belongs and the place common group (e.g., X2) matching the contiguous place common group (S731).

The existing place common group X1 of the modified vehicle request and the place common group matching the contiguous place common group will be hereinafter referred to as the contiguous place common group. The contiguous vehicle sharing group means one of one or more vehicle sharing groups included in the contiguous place common group. In FIG. 4, one vehicle sharing group Y3 is illustrated in the contiguous place common group X2, but two or more vehicle sharing groups may belong to the contiguous place common group X2.

When there is the contiguous vehicle sharing group (e.g., Y3) in step S731, the classification unit 130 may judge whether there is the vehicle request corresponding to the same condition request as the modified vehicle request among the vehicle requests which belong to the contiguous vehicle sharing group Y3 (S732).

When there is a comparison target request (e.g., the vehicle request of the user A9) corresponding to the same condition request as the modified vehicle request in step S732, the classification unit 130 may transmit a use authority transfer acceptance inquiry signal to the user terminal (e.g., 30_9) of the comparison target request corresponding to the same condition request (S733).

Alternatively, in step S732, when there is the comparison target request (e.g., the vehicle request of the user A9) corresponding to the same condition request as the modified vehicle request, the classification unit 130 may transmit the together riding acceptance inquiry signal to the user terminal (e.g., 30_9) which makes the comparison target request corresponding to the same condition request and the user terminal (e.g., 30_4) which makes the modified vehicle request, set the user terminal 30_9 of the comparison target request and the user terminal 30_4 of the modified vehicle request as one user group when each of the user terminal 30_9 of the comparison target request and the user terminal 30_4 of the modified vehicle request accepts the together riding, and determine one user group as the contiguous vehicle sharing group Y3, and the classification unit 130 may transmit the use authority transfer acceptance inquiry signal to the user terminal (e.g., 30_9) of the comparison target request corresponding to the same condition request when at least one of the user terminal 30_9 of the comparison target request and the user terminal 30_4 of the modified vehicle request does not accept the together riding (S733).

Here, the classification unit 130 allows one user group to share the use authority for the vehicle (e.g., 20_3) dispatched in the existing user terminal 30_9 which makes the comparison target request to determine one user group as the contiguous vehicle sharing group Y3.

The case where one user group shares the use authority for the vehicle (e.g., 20_3) dispatched in the existing user terminal 30_9 of the comparison target request may mean a case where multiple user terminals which belong to one user group are commonly dispatched with the vehicle 20_3 in a determined time zone to allow the user of each of the multiple user terminals to ride in the vehicle 20_3 together.

The use authority is a use authority for the vehicle 20_3 dispatched in the user terminal which makes the comparison target request A9.

Hereinafter, it will be assumed and described that the changed use time of the user A4 who makes the modified vehicle request is the same as the use time of the other user A9 included in the contiguous vehicle sharing group Y3. The classification unit 130 may determine whether the use authority is transferred by setting the vehicle request of the user A9 as the comparison target request.

When the user terminal 30_9 which makes the comparison target request accepts the use authority transfer subsequently to step S733 (S734), the classification unit 130 may transfer the vehicle use authority for the vehicle 20_3 of the user terminal 30_9 which makes the comparison target request to the user terminal which makes the modified vehicle request (S735).

In step S732, when there is no vehicle request corresponding to the same condition request as the modified vehicle request, the classification unit 130 may judge whether to determine the modified vehicle request as the contiguous vehicle sharing group Y3 (S736).

Hereinafter, it will be assumed and described that the changed use time of the user A4 who makes the modified vehicle request does not overlap with the use times of other users (A8 and A9) which belong to the contiguous vehicle sharing group Y3 (e.g., 21:00 to 23:00).

Subsequently to step S735 or in step S736, when the modified vehicle request may be included in the contiguous vehicle sharing group Y3, the classification unit 130 may determine the modified vehicle request as the contiguous vehicle sharing group Y3 (S737).

When there is no contiguous vehicle sharing group in the contiguous place common group X2 in step S731, when the user terminal 30_9 which makes the comparison target request does not accept the use authority transfer in step S734, or when the modified vehicle request may not be included in the contiguous vehicle sharing group Y3 in step S736, the classification unit 130 may transmit a signal for inquiring whether one vehicle is singly dispatched in the user terminal A4 which makes the modified vehicle request (S741).

When the dispatch unit 120 receives a response to be singly dispatched with one vehicle from the user terminal A4 which makes the modified vehicle request, the dispatch unit 120 may singly dispatch one vehicle in the user terminal A4 which makes the modified vehicle request.

Referring to FIG. 5, the classification unit 130 may correct the time table of the existing vehicle sharing group (S8). Further, the classification unit 130 may correct a time table of a vehicle sharing group to which the modified vehicle request is determined to belong according to step S727 or step S737.

The classification unit 130 may correct the vehicle sharing group-specific time table stored in the database 150 to the corrected vehicle sharing group-specific time table.

The dispatch unit 120 may dispatch one vehicle for each vehicle sharing group based on the corrected time table, and grant the use authority for the vehicle dispatched to the user of the vehicle request corresponding to the use time (S9).

One vehicle (e.g., 20_1) dispatched in the same vehicle sharing group (e.g., Y1) may be determined based on a desired vehicle type of the multiple vehicle requests (e.g., A1 to A4) which belong to the vehicle sharing group.

The dispatch unit 120 may grant the use authority for the vehicle dispatched for a predetermined time range based on the use time of the vehicle request to the user corresponding to the vehicle request. For example, for a predetermined time range (08:45 to 12:15) based on the use time (09:00 to 12:00) of the vehicle request of the user A1, the dispatch unit 120 may grant the use authority for the vehicle 20_1 to the user A1. Then, the use authority for a time of 08:45 to 12:15 is granted to the user terminal 30_1 of the user A1.

The dispatch unit 120 may store information on a vehicle dispatched in the vehicle sharing group in the database iso.

When the dispatch unit 120 grants the use authority for the dispatched vehicle, the control unit no may transmit information on the vehicle sharing group to multiple user terminals 30.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

What is claimed is:

1. A method for dispatching a vehicle, the method comprising:
receiving a plurality of vehicle requests including vehicle dispatch conditions from a plurality of user terminals, respectively, the vehicle dispatch conditions comprising a departure point, an arrival point, and a use time for a movement path;
determining a same place common group comprising one vehicle request having a first departure point and a first arrival point among the plurality of vehicle requests and at least one other vehicle request having the same departure point as any one of the first departure point and the first arrival point and having the same arrival point as the other one of the first departure point and the first arrival point among the plurality of vehicle requests;
determining a same vehicle sharing group comprising one vehicle request among a plurality of first vehicle requests which belongs to the same place common group and an other one vehicle request among the plurality of first vehicle requests having a use time later than a use time of the one vehicle request and having the same departure point as an arrival point of the one vehicle request;
generating a time table comprising information on a vehicle dispatched according to the use time and a user who requests the vehicle with respect to a plurality of second vehicle requests which belong to the same vehicle sharing group; and
dispatching one vehicle in the same vehicle sharing group.

2. The method of claim 1, wherein determining the same place common group further comprises matching one place common group including a vehicle request having a second departure point and a second arrival point among a plurality of place common groups and at least one other place common group including a vehicle request having a departure point contiguous to any one of the second departure point and the second arrival point and having an arrival point contiguous to the other one of the second departure point and the second arrival point as a contiguous place common group.

3. The method of claim 2, further comprising:
receiving a modified vehicle request including a changed use time from a user terminal which makes any one vehicle request of the plurality of second vehicle requests; and
determining the modified vehicle request as an existing vehicle sharing group when there is no first comparison target request corresponding to the same condition request as the modified vehicle request among the plurality of second vehicle requests and the modified vehicle request may be determined as the existing vehicle sharing group.

4. The method of claim 3, further comprising:
transmitting a transfer acceptance inquiry signal to a user terminal which makes the first comparison target request when there is the first comparison target request; and
determining the modified vehicle request as the existing vehicle sharing group when receiving a transfer acceptance signal from the user terminal which makes the first comparison target request.

5. The method of claim 4, further comprising:
transmitting a together riding acceptance inquiry signal to the user terminal which makes the first comparison target request and the user terminal which makes the modified request;
setting the user terminal which makes the first comparison target request and the user terminal which makes the modified request as one user group when both the user terminal which makes the first comparison target request and the user terminal which makes the modified request accept together riding; and
determining the one user group as the existing vehicle sharing group.

6. The method of claim 4, further comprising judging whether there is the other vehicle sharing group in an existing place common group of the modified vehicle request when there is no first comparison target request and the modified vehicle request may not be determined as the existing vehicle sharing group.

7. The method of claim 6, further comprising determining the modified vehicle request as the other vehicle sharing group when there is no second comparison target request corresponding to the same condition request as the modified vehicle request among a plurality of third vehicle requests which belong to the other vehicle sharing group when there is the other vehicle sharing group and the modified vehicle request may be determined as the other vehicle sharing group.

8. The method of claim 7, further comprising:
transmitting the transfer acceptance inquiry signal to a user terminal which makes the second comparison target request when there is the second comparison target request; and
determining the modified vehicle request as the other vehicle sharing group when receiving the transfer acceptance signal from the user terminal which makes the second comparison target request.

9. The method of claim 8, further comprising:
transmitting a together riding acceptance inquiry signal to the user terminal which makes the second comparison target request and the user terminal which makes the modified request;
setting the user terminal which makes the second comparison target request and the user terminal which makes the modified request as one user group when both the user terminal which makes the second comparison target request and the user terminal which makes the modified request accept together riding; and
determining the one user group as the other vehicle sharing group.

10. The method of claim 8, further comprising judging whether there is a contiguous vehicle sharing group in a contiguous place common group corresponding to the existing place common group of the modified vehicle request when there is no second comparison target request and the modified vehicle request may not be determined as the other vehicle sharing group.

11. The method of claim 10, further comprising determining the modified vehicle request as the contiguous vehicle sharing group when there is no third comparison target request corresponding to the same condition request as the modified vehicle request among a plurality of fourth vehicle requests which belong to the contiguous vehicle common group when there is the contiguous vehicle sharing group and the modified vehicle request may be determined as the contiguous vehicle sharing group.

12. The method of claim 11, further comprising:
transmitting a transfer acceptance inquiry signal to a user terminal which makes the third comparison target request when there is the third comparison target request; and
determining the modified vehicle request as the contiguous vehicle common group when receiving a transfer acceptance signal from the user terminal which makes the third comparison target request.

13. The method of claim 12, further comprising:
transmitting a together riding acceptance inquiry signal to the user terminal which makes the third comparison target request and the user terminal which makes the modified request;
setting the user terminal which makes the third comparison target request and the user terminal which makes the modified request as one user group when both the user terminal which makes the third comparison target request and the user terminal which makes the modified request accept together riding; and
determining the one user group as the contiguous vehicle sharing group.

14. The method of claim 12, further comprising transmitting a signal for inquiring whether one vehicle is singly dispatched in the user terminal which makes the modified vehicle request when there is no third comparison target request and the modified vehicle request may not be determined as the contiguous vehicle sharing group.

15. A server comprising:
an analyzer configured to analyze a plurality of vehicle requests including vehicle dispatch conditions comprising a departure point, an arrival point, and a use time for a movement path received from a plurality of user terminals, respectively, to generate information on the departure point, the arrival point, and the use time with respect to each of the plurality of vehicle requests; and
a classifier configured to:
determine a same place common group comprising one vehicle request having a first departure point and a first arrival point among the plurality of vehicle requests and at least one other vehicle request having the same departure point as any one of the first departure point and the first arrival point and having the same arrival point as the other one of the first departure point and the first arrival point among the plurality of vehicle requests; and
determine a same vehicle sharing group comprising one vehicle request among a plurality of first vehicle requests which belong to the same place common group and an other one vehicle request among the plurality of first vehicle requests having a use time later than a use time of the one vehicle request and having the same departure point as an arrival point of the one vehicle request.

16. The server of claim 15, wherein:
in response to receiving a use time change request from one of the plurality of user terminals, the analyzer is configured to analyze the received use time change request to generate information on the changed use time; and
the classifier is configured to determine the place common group and the vehicle sharing group based on the information on the use time change request and to correct a time table of the vehicle sharing group.

17. The server of claim 16, wherein the classifier is configured to:
judge whether to determine a modified vehicle request for making the use time change request an existing vehicle sharing group to which the modified vehicle request belongs;
when the modified vehicle request may not be determined as the existing vehicle sharing group, judge whether to determine the vehicle as the other vehicle sharing group in an existing place common group to which the modified vehicle request belongs; and
when the modified vehicle request may not be determined as the other vehicle sharing group, judge whether to determine the vehicle as a contiguous vehicle sharing group in a contiguous place common group corresponding to the existing place common group to which the modified vehicle request belongs.
